(19) United States
(12) Patent Application Publication
(10) Pub. No.: US 2012/0103823 A1
(43) Pub. Date: May 3, 2012

(54) Method for detecting individual oxidant species and halide anions in a sample using differential pulse non-stripping voltammetry

(76) Inventors: Badawi M. Dweik, Foxboro, MA (US); Gwendolynne Merlen, Somerville, MA (US); Linda A. Tempelman, Lincoln, MA (US)

(21) Appl. No.: 13/317,151

(22) Filed: Oct. 11, 2011

Related U.S. Application Data
(60) Provisional application No. 61/404,728, filed on Oct. 8, 2010.

(51) Int. Cl. G01N 27/403; C25B 15/02; G01N 27/26

(52) U.S. Cl. 205/335; 204/406; 204/242; 205/780

(57) ABSTRACT

Method for electrochemically detecting different oxidant and halide anion species in a sample. According to one embodiment, the method uses a sensor including a boron-doped diamond working electrode, a platinum mesh counter electrode, a silver/silver chloride reference electrode, a potentiostat coupled to the three electrodes, and a computer coupled to the potentiostat. The sensor measures current resulting from differential pulse non-stripping voltammetry, thereby enabling different oxidants and halide anions from a plurality of such species to be detected by distinct responses. Peaks in the current signal result at characteristic voltages when a species is oxidized to a higher oxidation state, and the concentration of a particular species is determined by the magnitude of the current peak. The sensor response time is rapid and shows high sensitivity and selectivity for oxidants and halide anions. The sensor may be a hand-held or in-line device and may be used in a feedback-control system.

### CROSS-REFERENCE TO RELATED APPLICATIONS

The present application claims the benefit under 35 U.S.C. 119(e) of U.S. Provisional Patent Application No. 61/404,728, filed Oct. 8, 2011, the disclosure of which is incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. N00014-09-M-0444 awarded by the Office of Naval Research.

### BACKGROUND OF THE INVENTION

The present invention relates generally to methods for detecting oxidants and halide anions in a sample and relates more particularly to a new method for detecting individual oxidant species and halide anions in a sample using differential pulse non-stripping voltammetry.

There are many situations in which the detection of one or more oxidant species in a sample is desirable. For example, one common technique for the commercial manufacture of sodium hypochlorite, i.e., chlorine bleach, comprises the electrolysis of a salt solution, which initially generates chlorine gas and then also generates, amongst other things, hypochlorite, hypochlorous acid, chlorate, and chlorite. As can readily be appreciated, for quality control purposes and the like, it would be desirable to be able to detect the level of hypochlorite within such a sample so that, based on the detected level, one can thereafter modify the pH of the solution, if necessary, in order to obtain a higher proportion of hypochlorite relative to the other chlorine-containing oxidant species produced.

Electrolytic chlorination systems similar to that described above for generating commercial bleach are also commonly found on ships and submarines to produce disinfecting agents used, for example, to control the biofouling of desalination membranes. Such systems often use seawater, as opposed to a prepared salt solution, as a starting material. Bromide ions are typically present in small amounts in seawater; consequently, in addition to the chlorine-containing oxidant species that are produced by the aforementioned electrolysis process, bromate is also typically produced in small amounts. However, bromate is a suspected carcinogen; therefore, a high level of bromate in a disinfecting solution used to treat a desalination membrane is undesirable. As a result, it would be desirable to detect the level of bromide in such a solution to allow control of bromate contamination risk.

Electrolytic chlorination systems of the aforementioned type are also used in many water sanitation systems including many drinking water sanitation systems. As can be appreciated, it would be desirable to detect the level of particular oxidants that are present in a water sample to determine the suitability of a water supply for drinking or for other uses.

A number of different techniques currently exist for determining the level of an oxidant in a sample. One such technique, which is used to detect chlorine, uses spectrophotometry coupled with flow injection analysis. Briefly, this technique comprises adding a chromogenic reagent to a sample suspected of containing chlorine. Where oxidation of the reagent occurs, a colored product is produced which can be monitored at a particular wavelength, with absorbance being proportional to the concentration of chlorine in the sample. One drawback of this technique is that the appropriate selection of a chromogenic reagent is crucial in order to avoid the formation of a carcinogenic compound.

Another technique, which is commonly used to detect chlorine, is iodometric titration. Iodometric titration is predicated on the principle that chlorine at a pH of less than 8 oxidizes iodide to iodine. As a result, iodometric titration involves the addition of a reagent, such as potassium iodide, to a sample suspected of containing chlorine. Starch is then added to the sample. If chlorine is present, the starch forms a blue complex, indicative of liberated iodine. The solution is then titrated with sodium thiosulfate until the blue color disappears. The amount of added titrant is proportional to the concentration of chlorine that was present in the sample.

Still another technique, which is commonly used to detect free and residual chlorine, is amperometric titration. According to this technique, free and residual chlorine are titrated with reducing compounds, such as Na₂S₂O₃ or phenylarsine oxide (PAO). The experimental setup for this technique consists of two platinum electrodes where a small voltage is applied and an electrical current is generated. Oxidation and reduction of Cl⁻ and Cl₂ occur at both electrodes, respectively. The gradual addition of PAO irreversibly reduces Cl₂ until complete reduction of Cl₂ takes place, thus terminating the reaction and dropping the current to zero. A plot of current versus titrant (PAO) volume is obtained where the abrupt change in current is defined as the end point. The concentration of chlorine in the sample is proportional to the exact amount of titrant added until the current drops to zero.

The aforementioned amperometric titration technique requires a higher degree of skill and care than does the above-described colorimetric method. The above-described iodometric method is less sensitive than the amperometric method but is suitable for measuring total chlorine concentrations higher than 1 mg/L. However, since these methods are based on the visual judgment of the measurer, there is a shortcoming in that differences may arise in the measured value. There is also a shortcoming with these methods in that waste liquid treatment is required after the measurement. Furthermore, there is a shortcoming with these methods in that these methods are time-consuming and cannot be conducted as part of an on-line analytical system.

Another type of technique for detecting an analyte of interest is a direct electrochemical oxidation technique. This type of technique has been used extensively in analysis for its advantages in real-time measurement with the requisite stability, accuracy, reproducibility, rapidity, and economical efficiency. Over the years, a variety of working (sensing) electrodes for electrochemically oxidizing inorganic or organic species have been developed. The properties of a working electrode in an electrochemical cell are critically important since the working electrode is directly involved in the oxidation or reduction of the organic molecule (analyte). The most common working electrode materials for direct electrochemical oxidation have been carbon-based or have been made from metals, such as platinum, silver, gold, mercury, or nickel. Generally, on such electrodes, the species to be selectively detected by electrochemical oxidation are species that can be oxidized below the voltage before oxygen begins evolving at the electrode material, i.e., the “voltage limit.” For platinum electrodes, for example, the operating limit is up to +1.2 or +1.3 V versus an Ag/AgCl reference electrode.

An example of a direct electrochemical oxidation technique used to detect oxidants in a sample is disclosed in U.S. Patent Application Publication No. US 2007/0114137 A1, inventors Nomura et al., published May 24, 2007, which is incorporated herein by reference. More specifically, this patent application publication describes a residual chlorine measuring method that includes bringing a counter electrode, a working electrode, and a reference electrode into contact with a sample solution containing a residual chlorine, applying a voltage between the counter electrode and the working electrode, and measuring a current value to calculate a concentration of the residual chlorine. The working electrode is an electrically conductive diamond electrode to which an element selected from the group of boron, nitrogen and phosphorus is doped into a diamond coating. The reference electrode is a silver/silver chloride electrode. A current value is measured when a potential of the electrically conductive working electrode is linearly scanned in the anodic direction between +0.5V to +1.5V when compared to a potential of the silver/silver chloride reference electrode.

Although the aforementioned direct electrochemical oxidation technique has certain advantages over the other techniques described above, this technique nonetheless has the shortcoming that one cannot determine individual levels of different oxidant species present in a sample. In other words, in a sample containing a plurality of oxidant species, this technique is capable only of detecting the total concentration of all oxidant species present in the sample.

### SUMMARY OF THE INVENTION

It is an object of the present invention to provide a novel method for detecting oxidants and halide anions in a sample.

It is another object of the present invention to provide a method as described above that overcomes at least some of the shortcomings associated with existing methods for detecting oxidants and halide anions in a sample.

Therefore, according to one aspect of the invention, there is provided a method for detecting at least one oxidant species in a sample, the method comprising the steps of (a) providing a sensor, the sensor comprising (i) a working electrode, the working electrode comprising a boron-doped diamond electrode, (ii) a counter electrode, (iii) a reference electrode, (iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and (v) a computer, the computer being electrically coupled to the potentiostat to control the voltage applied by the potentiostat and to record the resulting current detected by the potentiostat; (b) exposing the working electrode, the counter electrode, and the reference electrode of the sensor to the sample; (c) operating the potentiostat, using differential pulse non-stripping voltammetry, to apply a voltage between the working electrode and the reference electrode in such a manner as to cause the generation of a current between the working electrode and the counter electrode that is indicative of the at least one oxidant species to be detected, whereby said current is measured by the potentiostat; and (d) comparing the measured current to an appropriate standard for the at least one oxidant species.

According to another aspect of the invention, there is provided a method for detecting more than one oxidant or halide anion species in a sample, the method comprising the steps of (a) providing a sensor, the sensor comprising (i) a working electrode, the working electrode comprising a boron-doped diamond electrode, (ii) a counter electrode, (iii) a reference electrode, (iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and (v) a computer, the computer being electrically coupled to the potentiostat to control the voltage applied by the potentiostat and to record the resulting current detected by the potentiostat; (b) exposing the working electrode, the counter electrode, and the reference electrode of the sensor to the sample; (c) operating the potentiostat, using differential pulse non-stripping voltammetry, to apply a voltage between the working electrode and the reference electrode in a scanning manner that distinguishes the different oxidant species to be detected by the generation of a current between the working electrode and the counter electrode at a characteristic potential, whereby said current is measured by the potentiostat; and (d) comparing the measured current to appropriate standards to enable more than one oxidant or halide anion species to be detected and distinguished from one another.

According to yet another aspect of the invention, there is provided a method for detecting at least one halide anion species in a sample, the method comprising the steps of (a) providing a sensor, the sensor comprising (i) a working electrode, the working electrode comprising a boron-doped diamond electrode, (ii) a counter electrode, (iii) a reference electrode, (iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and (v) a computer, the computer being electrically coupled to the potentiostat to control the voltage applied by the potentiostat and to record the resulting current detected by the potentiostat; (b) exposing the working electrode, the counter electrode, and the reference electrode of the sensor to the sample; (c) operating the potentiostat, using differential pulse non-stripping voltammetry, to apply a voltage between the working electrode and the reference electrode in such a manner as to cause the generation of a current between the working electrode and the counter electrode that is indicative of the at least one halide anion species to be detected, whereby said current is measured by the potentiostat; and (d) comparing the measured current to an appropriate standard for the at least one halide anion species.

According to still another aspect of the invention, there is provided a method for producing a chlorine-oxidant containing solution, said method comprising the steps of (a) providing an electrochlorinator; (b) producing a chlorine-oxidant containing solution with the electrochlorinator; (c) detecting the level of at least one chlorine-containing oxidant in the chlorine-oxidant containing solution; and (d) providing feedback control of the electrochlorinator based on the detected level of the at least one chlorine-containing oxidant.

According to still yet another aspect of the invention, there is provided an electrolytic chlorination system comprising (a) an electrochlorinator for producing a solution containing at least one chlorine-containing oxidant; and (b) a sensor, the sensor being fluidly coupled to the electrochlorinator for analyzing the solution produced by the electrochlorinator and being electrically coupled to the electrochlorinator for providing feedback control of the electrochlorinator based on analysis of the solution produced by the electrochlorinator.

Additional objects, as well as aspects, features and advantages, of the present invention will be set forth in part in the description which follows, and in part will be obvious from the description or may be learned by practice of the invention. In the description, reference is made to the accompanying drawings which form a part thereof and in which is shown by way of illustration various embodiments for practicing the invention. The embodiments will be described in sufficient detail to enable those skilled in the art to practice the invention, and it is to be understood that other embodiments may be utilized and that structural changes may be made without departing from the scope of the invention. The following detailed description is, therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate various embodiments of the invention and, together with the description, serve to explain the principles of the invention. In the drawings wherein like reference numerals represent like parts:

FIG. 1 is a simplified schematic diagram of one embodiment of a sensor that may be used in accordance with the teachings of the present invention to detect individual oxidant or halide anion species in a sample using differential pulse non-stripping voltammetry;

FIG. 2(a) is a simplified schematic diagram of one embodiment of an electrochlorinator system constructed according to the teachings of the present invention, the electrochlorinator system including the sensor of FIG. 1 as part of a feedback control;

FIG. 2(b) is a simplified schematic diagram of one embodiment of a water sanitation system constructed according to the teachings of the present invention, the water sanitation system including the sensor of FIG. 1 as part of a feedback control;

FIG. 3(a) is a graph depicting several scans for different concentrations of hypochlorite spiked in a 3.5% NaCl aqueous solution as sodium hypochlorite (NaClO), as discussed in Example 1;

FIG. 3(b) is a graph depicting the linear correlation of peak height to concentration for the scans of FIG. 3(a), as discussed in Example 1;

FIG. 4 is a graph depicting several scans for distinct responses to available chlorine present as hypochlorous acid (HClO) and hypochlorite (ClO⁻) as a function of pH, as discussed in Example 2;

FIG. 5(a) is a graph depicting several scans for different concentrations of chlorite (ClO₂⁻) spiked in seawater, as discussed in Example 3;

FIG. 5(b) is a graph depicting the linear correlation of peak height to chlorite concentration for the scans of FIG. 5(a), as discussed in Example 3;

FIG. 6 is a graph depicting several scans of alternating additions of chlorite and sodium hypochlorite concentration, as discussed in Example 3;

FIG. 7(a) is a graph depicting several scans for different concentrations of bromide in filtered seawater, as discussed in Example 4;

FIG. 7(b) is a graph depicting the linear correlation of peak height to bromide concentration for the scans of FIG. 5(a), as discussed in Example 4;

FIG. 8(a) is a graph depicting several scans for different concentrations of bromide and sodium hypochlorite spiked in 3.5% NaCl solution, as discussed in Example 5;

FIG. 8(b) is a graph depicting the correlation of peak height to bromide concentration and to hypochlorite concentration for the scans of FIG. 8(a), as discussed in Example 5;

FIG. 9 is a graph depicting several scans of seawater in an electrochlorinator measured at 10-minute intervals as the electrochlorinator generated hypochlorite and hypochlorous acid, as discussed in Example 6;

FIG. 10(a) is a graph depicting the peak heights of the higher voltage hypochlorous acid response and the lower voltage hypochlorite response plotted against total available chlorine concentration as determined by iodometric titration, as discussed in Example 6; and

FIG. 10(b) is a graph depicting the total response area (hypochlorite and hypochlorous acid responses) plotted against total available chlorine concentration, as discussed in Example 6.

### DETAILED DESCRIPTION OF THE INVENTION

The present invention is directed at a method for electrochemically detecting individual oxidant species in a sample, said individual oxidant species including, but not being limited to, at least one of, and preferably a plurality of, hypochlorite (ClO⁻), hypochlorous acid (HClO), chlorite (ClO₂⁻). The present invention is also directed at detecting halide anions in a sample including, but not limited to, chloride (Cl⁻) and bromide (Br⁻). As will be discussed further below, according to a preferred embodiment, said method involves the use of a sensor, said sensor comprising a working electrode, a reference electrode, and a counter electrode, the working electrode preferably comprising a boron-doped diamond electrode, which may be a boron-doped diamond electrode microarray. The sensor also comprises a potentiostat, the potentiostat being electrically coupled to each of the working electrode, the counter electrode, and the reference electrode so as to apply a voltage between the working electrode and the reference electrode and so as to measure current between the working electrode and the counter electrode. The sensor further comprises a computer, the computer being electrically coupled to the potentiostat to control the voltage applied by the potentiostat and to record the resulting current detected by the potentiostat. According to the present method, the working electrode, the counter electrode, and the reference electrode of the above-described sensor are then brought into contact with the sample, and the potentiostat is operated using differential pulse non-stripping voltammetry to apply a voltage between the working electrode and the reference electrode in such a manner as to cause the generation of a current between the working electrode and the counter electrode that is indicative of the oxidant or halide anion species to be detected, whereby said current is measured by the potentiostat. The measured current is then compared to appropriate standards for the oxidant species being detected.

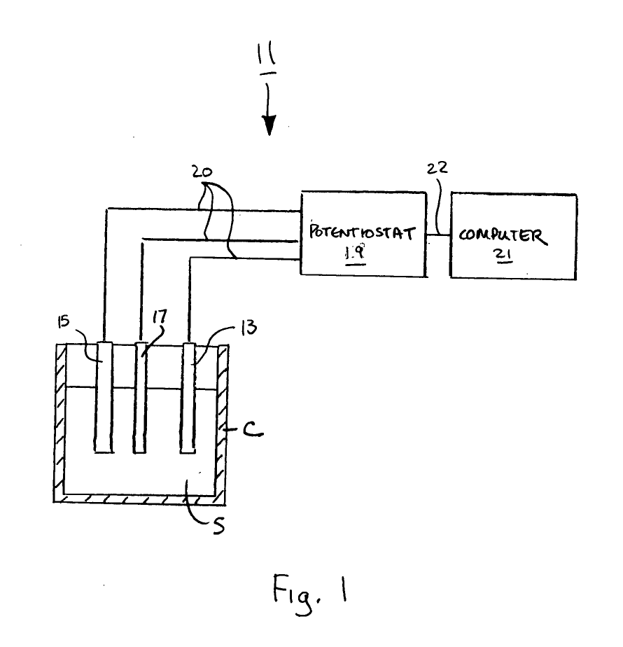

Referring now to FIG. 1, there is schematically shown one embodiment of a sensor that may be used to perform the method of the present invention, the sensor being represented generally by reference numeral 11. For illustrative purposes, sensor 11 is shown being used to detect oxidant species present in a sample solution S that is disposed within a container C.

Sensor 11 may comprise a working electrode 13, a reference electrode 15, a counter electrode 17, a potentiostat 19, and a computer 21.

Working electrode 13 is used to apply a voltage to the sample solution. In the present embodiment, working electrode 13 may be, for example, a boron-doped diamond (BDD) electrode. The boron doping imparts conductivity to the otherwise insulating diamond structure, and this electrode material allows oxidants, such as hypochlorite, hypochlorous acid, or chlorite, to be oxidized at high anodic potentials without significant interference from halide anions, such as bromide and chloride, which may be detected at higher potentials, and without interference from water oxidation, which is shifted to yet a higher potential at BDD. The aforementioned boron-doped diamond electrode may be, for example, a macro boron-doped diamond electrode or may be in the form of a microarray, which may comprise an array of micro-dimension circles or micro-width lines of BDD. Macro BDDs and microarray BDDs may be manufactured with a range of geometries, boron doping levels, and polycrystalline grain sizes, depending on the desired electrochemical properties. Working electrode 13 may be, for example, a 10 mm² boron-doped diamond electrode. Alternatively, an illustrative example of a microarray design suitable for use in the present invention may comprise a total electrode area of 0.5 cm² with 0.057 cm² active area comprising 25 μm diameter microdots separated by 120 μm and with a boron doping level of 6000 ppm. Working electrode 13 may be fixed by a holding member (not shown) so as to be immersed in the sample solution S disposed within container C.

Reference electrode 15 is used as the standard of the potential of the working electrode 13. In the present embodiment, reference electrode 15 may be, for example, a saturated silver/silver chloride (Ag/AgCl) electrode, preferably a leakless saturated silver/silver chloride electrode of the type commercially available from eDAQ Pty Ltd (Denistone East, Australia). Reference electrode 15 may be fixed by the holding member (not shown) so as to be immersed in the sample solution S disposed within container C.

Counter electrode 17 makes a current flow in the working electrode 13 when setting working electrode 13 to a potential and is connected to the working electrode 13 in series. In the present embodiment, counter electrode 17 may be, for example, a platinum (Pt) mesh electrode. Like reference electrode 15, counter electrode 17 may be fixed by the holding member (not shown) so as to be immersed in the sample solution S disposed within container C.

Potentiostat 19 is electrically coupled to each of working electrode 13, reference electrode 15, and counter electrode 17 by wires 20 so as to apply a voltage between working electrode 13 and reference electrode 15 in the manner to be discussed below and so as to measure the resulting current between working electrode 13 and counter electrode 17. Peaks in the current signal result at characteristic voltages when an oxidant is oxidized to a higher oxidation state, and concentration of the particular oxidant is determined by the magnitude of the current peak height or area.

Computer 21 is electrically coupled to potentiostat 19 by a wire 22 and controls the voltage applied by potentiostat 19. In addition, computer 21 records the current detected by potentiostat 19 and compares the measured current to appropriate standards for the oxidant species being detected. In accordance with the teachings of the present invention, computer 21 operates potentiostat 19 using differential pulse non-stripping voltammetry. For purposes of the present specification and claims, the term “differential pulse non-stripping voltammetry” is to be contrasted with the terms “differential pulse voltammetry” and “differential pulse stripping voltammetry” in that “differential pulse non-stripping voltammetry” does not involve the deposition of a desired species onto an electrode prior to applying a voltage to the electrode and, therefore, does not involve the “stripping” of the species from the electrode. Moreover, in accordance with the present invention, “differential pulse non-stripping voltammetry” is to be construed to encompass the application of a scanning voltage in an anodic direction, in a cathodic direction, in an anodic direction followed by a cathodic direction, or in a cathodic direction followed by an anodic direction. Where scanning is conducted in both an anodic direction and a cathodic direction, the results could be summed, averaged, expressed as a ratio, compared to one another, etc.

In performing differential pulse non-stripping voltammetry, one or more scan parameters may need to be varied depending, for example, on the sample matrix, the type of boron-doped diamond electrode used, and the oxidants being detected. Such parameters may include, but need not be limited to, the start potential and the end potential for the scan, the speed of the scan, the step size between pulses, the pulse height, and the pulse width. Illustrative parameters for an anodic scan using a BDD macro electrode may include a start potential (versus a silver/silver chloride reference electrode) in the range of +0.2V to +0.3V, an end potential (versus a silver/silver chloride reference electrode) in the range of +1.5V to +3V (with an end potential of +1.5V being suitable for detection of hypochlorite, hypochlorous acid, and chlorite and with an end potential of +1.8V being suitable for the additional detection of bromide), a scan rate of 50 mV/s, a step size of 10 mV, a pulse height of 50 mV, and a pulse width of 50 ms. When the voltage is scanned, charging currents due to ionic migration produce a background current, and when voltage becomes sufficiently high to drive an oxidation reaction of a species at the surface of the sensing electrode, more current is produced until the diffusion limited current of the oxidizable species is reached. By superimposing pulsed voltage on the voltage scan, the rate of oxidation reactions is increased during the pulses, resulting in more current. By subtracting current during the pulses from current just before the pulses, the charging background current is subtracted out of the signal while the oxidation reaction current creates a differential current signal at a characteristic voltage for the reaction. The current increases with concentration of the oxidizable species; thus, measurement of the differential current signals in a scan provides a means of measuring concentration of oxidizable species. The oxidation reactions indicated in Table 1 allow the concentration of residual oxidants to be monitored in this way. (The sensing of oxidants is accomplished by measuring current from oxidation of the oxidants, which may occur by the following reactions at voltages close to the indicated thermodynamic potentials.) A potentiostat applies the voltage algorithm and measures current during and before the pulses, and data acquisition software computes the difference between current during the pulse and pre-pulse. The data processing software plots the differential currents against the voltage scan, and peak detection algorithms in the software determine peak heights at the characteristic voltages corresponding to the oxidants of interest. Calibration information is then used to correlate the current peaks with actual concentration of species.

TABLE 1

| | Thermodynamic Oxidation |
|---|---|
| Oxidation Reaction | Potential vs. SHE |
| HClO + H₂O → HClO₂ + 2H⁺ + 2e⁻ | +1.645 ¹ |
| ClO⁻ + H₂O → ClO₂⁻ + 2H⁺ + 2e⁻ | +0.66 ¹ |
| HClO₂ + H₂O → ClO₃⁻ + 3H⁺ + 2e⁻- | +1.214 ¹ |
| HClO₂ → ClO₂ + H⁺ + e⁻ | +1.277 ¹ |
| ClO₂⁻ → ClO₂ + e⁻ | 0.954 ¹ |
| ClO₂⁻ + H₂O → ClO₃⁻ + 2H⁺ + 2e⁻ | +0.33 ¹ |
| 2Br⁻ → Br₂(aq) | +1.087 ¹ |

¹ Source: CRC Handbook of Chemistry and Physics

Some of the advantages of sensor 11 are (1) that it permits direct, continuous analysis of total residual oxidants in seawater and other aqueous media without sample conditioning; (2) oxidant species and halide anions respond at distinct characteristic potentials, such that there is no interference between seawater chloride ion and oxidant species response, for example; (3) that the boron-doped diamond electrode allows high voltages to be applied without interference from water oxidation so that anodic potentials that oxidize the oxidants and halides can be used for sensing; (4) that the response time is under a minute; (5) that it has the ability to operate in varying levels of pH; (6) that there is no requirement for added reagents; (7) that it provides a user-friendly interface to observe monitoring and control; and (8) that it has high sensitivity and long-term response stability.

Sensor 11 has utility in a number of military, government and civilian applications. It could be used in monitoring ship ballast tanks, power plant cooling systems, water treatment facilities, swimming pools, and heating, ventilating, and air conditioning (HVAC) systems.

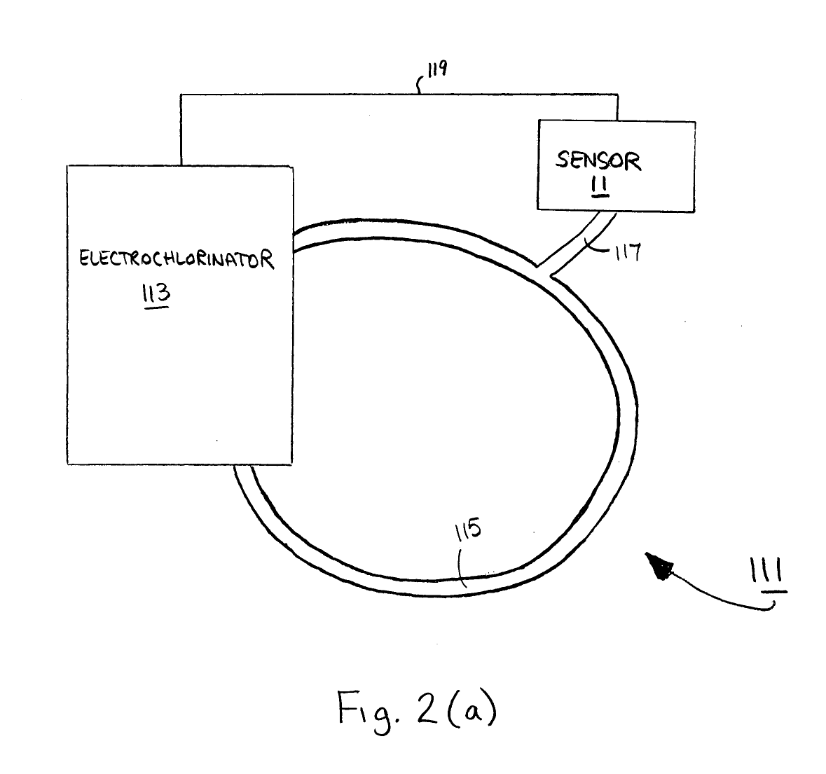

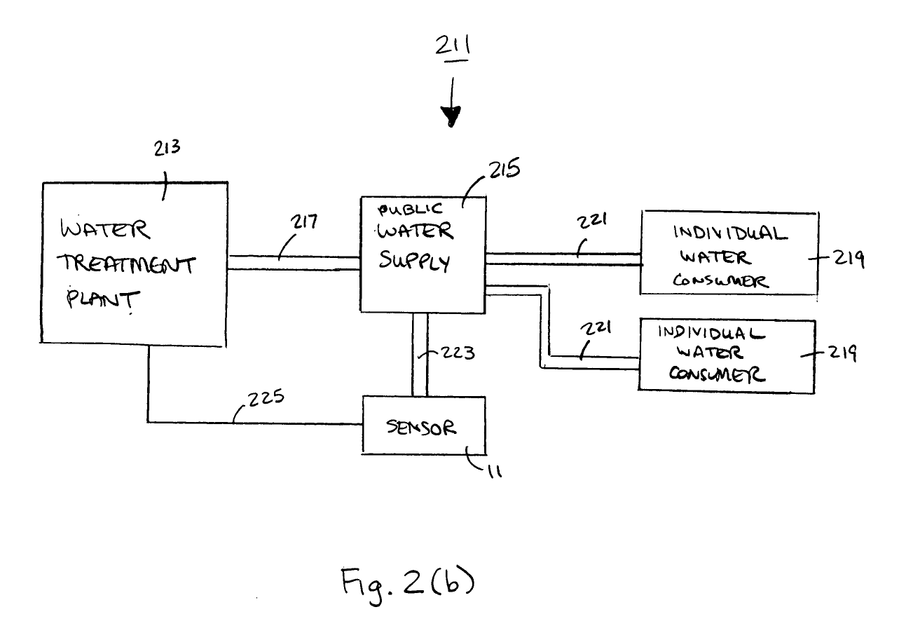

As noted above, sensor 11 may be operated in several technological embodiments for practical applications. For example, referring now to FIG. 2, there is schematically shown one embodiment of an electrochlorinator system constructed according to the teachings of the present invention, the electrochlorinator system being represented generally by reference numeral 111.

System 111 may comprise an electrochlorinator 113, which may be generally similar to a conventional electrochlorinator. System 111 may further comprise a circulation loop 115, through which solution generated by electrochlorinator 113 may be circulated. System 111 may further comprise sensor 11, which may be coupled to circulation loop 115 through a sampling tube 117 and which may be electrically coupled to electrochlorinator 113 through a wire 119. In this manner, solution generated by electrochlorinator 113 may be analyzed in near-real time by sensor 11. Moreover, if necessary, sensor 11 may be used to provide feedback control of electrochlorinator 113.

Referring now to FIG. 2(b), there is shown one embodiment of a water sanitation system constructed according to the teachings of the present invention, said water sanitation system being represented generally by reference numeral 211.

System 211 may comprise a water treatment plant 213, which may be conventional in nature, for rendering water suitable for human use and/or consumption. System 211 may also comprise a public water supply 215, fluidly coupled to plant 213 by conduit 217, for storing water treated at plant 213. System 211 may additionally comprise individual water consumers 219, such as residences or businesses, fluidly coupled to water supply 215 by conduits 221. (It is to be understood that, whereas two consumers 219 are shown in FIG. 2(b), this number is merely illustrative and the number of consumers 219 could also be more than two or less than two.) System 211 may further comprise sensor 11, which may be fluidly coupled to supply 215 through a conduit 223 to periodically monitor or to continuously monitor one or more oxidants present in the water at supply 215. Sensor 11 may be electrically coupled to plant 213 through wiring 225 to provide feedback control based on the one or more monitored oxidants.

The present invention is also directed towards pairing the robust sensing electrode platform with the differential pulse non-stripping voltammetric technique for enhanced sensitivity. The differential pulse non-stripping voltammetric technique subtracts charging currents due to ion migration, which are significant in high ionic strength media like seawater, from the signal so that the signal reflects actual redox processes, leading to enhanced sensitivity. Therefore, differential pulse non-stripping voltammetry scans can be used to sense oxidants from the current generated when they are oxidized to higher oxidation states.

The present invention is further directed at the regeneration of the boron-doped diamond surface by application of high anodic voltages for a short period of time to mineralize contaminants on the boron-doped diamond due to biofouling that may occur after prolonged use. Boron-doped diamond will withstand strong oxidizing voltages that oxidize organic materials at the electrode directly and by production of strong oxidants like hydroxyl radicals.

A brief summary of some of the results obtained using the present invention is as follows:

With boron-doped diamond electrodes and the differential pulse non-stripping voltammetry technique, simple, fast, stable and sensitive detection of total residual oxidants was achieved. Distinct detection of halide anions at separate characteristic potentials in the differential pulse non-stripping scan was also achieved. The sensor analyzed oxidants and halide anions in samples, including seawater, in the ppm range.

Optimum operating parameters for stability of measurements and detection of oxidants species at ppm detection limits were determined.

Results demonstrated excellent sensor linearity over a wide concentration range (2-1000 ppm hypochlorite). A linear relationship (r²=0.99) was found for the concentration range of 10-1000 ppm hypochlorite with signal/noise ratio (S/N) up to 300/1.

The lower detection limit was shown to be 2 ppm hypochlorite.

Excellent reproducibility and stability was demonstrated over more than 100 tests.

The presence of chloride ions at levels commonly found in seawater did not interfere with the detection of total residual oxidants (TRO). (Other than water, chloride ions are the most severe potential interference in seawater if they were to be converted to chlorine gas at the sensing electrode at the same anodic potentials at which oxidant species respond.)

Fast sensor response time (16 seconds per detection scan) provides near real-time monitoring capabilities. This meets and exceeds the needs of all anticipated measurement applications.

The sensor is able to detect and distinguish among oxidant species and halide anion species including HClO, ClO⁻, ClO₂⁻, Br⁻ and Cl⁻.

The sensor response to TRO species in typical seawater shows an excellent correlation with the (off-line) reference analytical method (EPA Method 330.3). The results indicate that the boron-doped diamond electrode is superior to the other previously used non-boron-doped diamond electrodes.

The following examples are provided for illustrative purposes only and are in no way intended to limit the scope of the present invention:

### Example 1

### NaClO detection in 3.5% NaCl

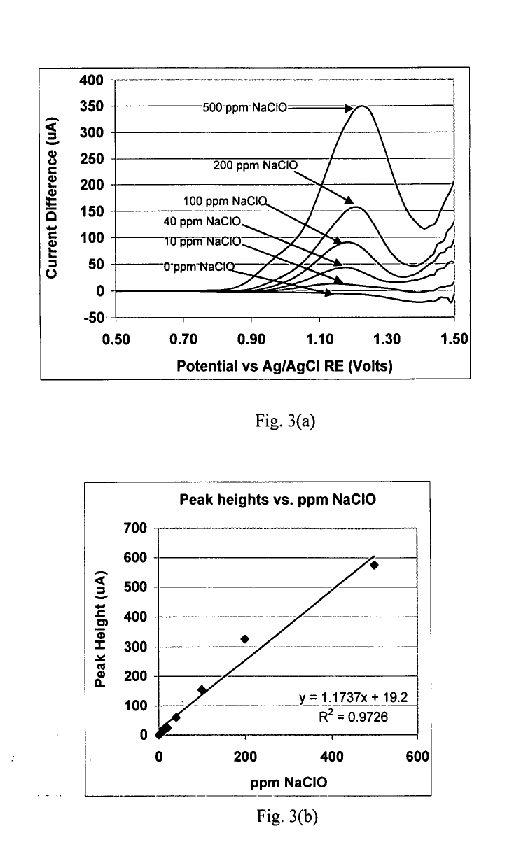

Referring now to FIG. 3(a), there are shown various scans obtained using sensor 11 (with a 10 mm² BDD working electrode 13) and differential pulse non-stripping voltammetry to detect various concentrations of hypochlorite (ClO⁻) in samples containing a high level of chloride (i.e., 3.5% NaCl aqueous solution). As can be seen, chloride oxidation did not produce an interfering response. Moreover, as can be seen in FIG. 3(b), the response to hypochlorite was linearly concentration dependent.

### Example 2

### pH Effects on Bleach Peak in Seawater Due to Co-Existence of HClO and ClO⁻ Species near pKa

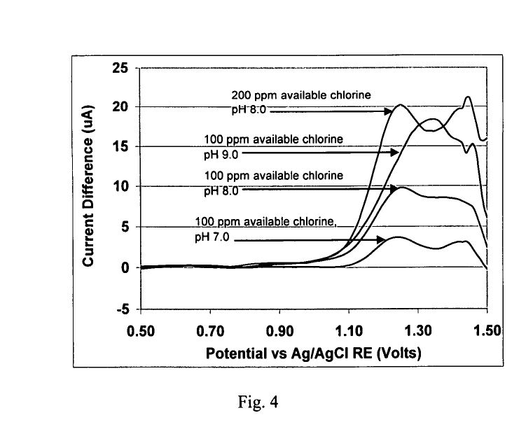

Referring now to FIG. 4, the response of sensor 11 (with a 10 mm² BDD working electrode 13) to ClO⁻ and HClO using differential pulse non-stripping voltammetry was tested by adjusting the pH of a 100 ppm ClO⁻ spiked seawater sample from 7 to 9 using HCl or NaOH. As can be seen, the pH change altered the magnitude and shape of the response curves. At low pH, a double peak was observed. However, as pH reached 8.2, the response showed one distinguishable peak. Therefore, the present technique can be used to distinguish the protonated and deprotonated forms from one another, which is a useful feature for the precise determination of oxidizing power of a sample since these two species have different oxidizing strength.

### Example 3

### ClO₂⁻ Detection in Ultra-Filtered Seawater

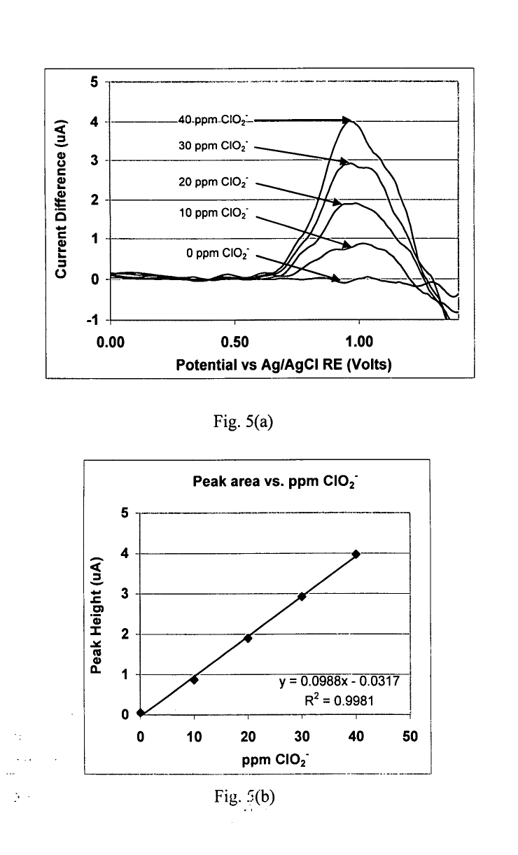

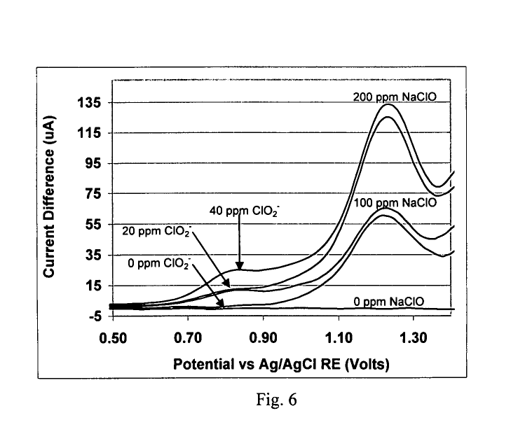

Referring now to FIG. 5(a), there are shown various scans obtained using sensor 11 (with a 10 mm² BDD working electrode 13) and differential pulse non-stripping voltammetry to detect chlorite spiked in seawater at various concentrations. As can be seen in FIG. 5(b), the response to chlorite in seawater was linearly concentration dependent. Moreover, as can be seen in FIG. 6, using sensor 11 and differential pulse non-stripping voltammetry, distinct responses were obtained to alternating additions of chlorite and hypochlorite.

### Example 4

### Br⁻ detection in ultra-filtered seawater

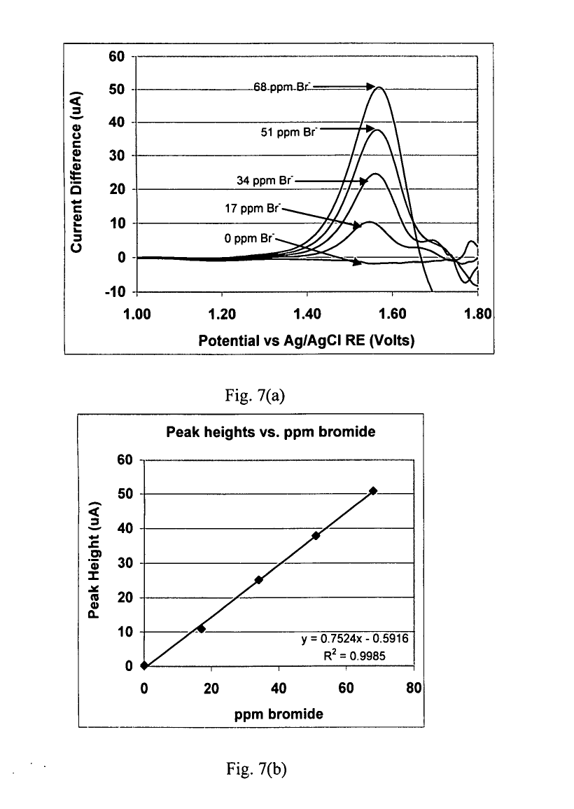

Referring now to FIG. 7(a), there are shown various scans obtained using sensor 11 (with a 10 mm² BDD working electrode 13) and differential pulse non-stripping voltammetry to detect bromide spiked in seawater at various concentrations. As can be seen in FIG. 7(b), the response to bromide in seawater was linearly concentration dependent.

### Example 5

### Br⁻ and ClO⁻ Detection in Spiked 3.5% NaCl Solution

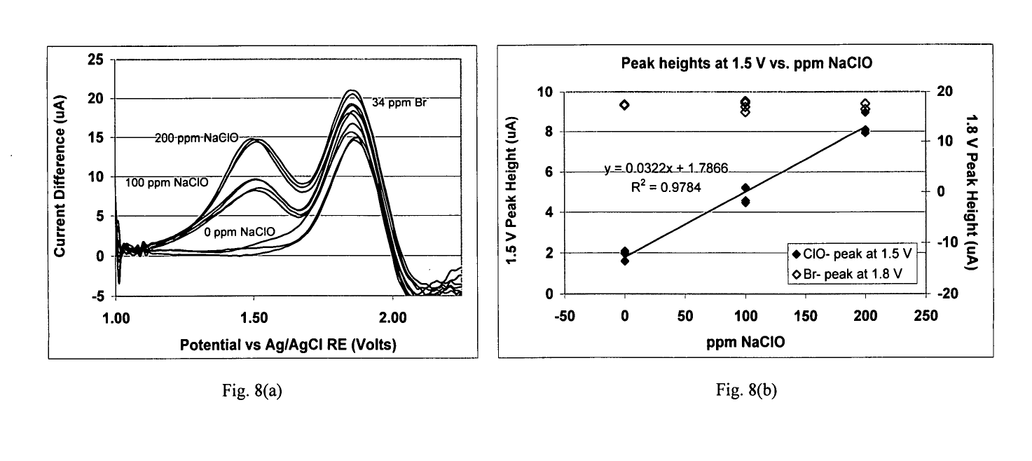

Referring now to FIG. 8(a), there are shown various scans obtained using sensor 11 (with a microarray BDD working electrode 13) and differential pulse non-stripping voltammetry to detect bromide and hypochlorite at various concentrations in 3.5% NaCl solution. The correlations of peak height to bromide concentration and to hypochlorite concentration are shown in FIG. 8(b).

### Example 6

### In-Situ Monitoring of Oxidants Generated by an Electrochlorinator

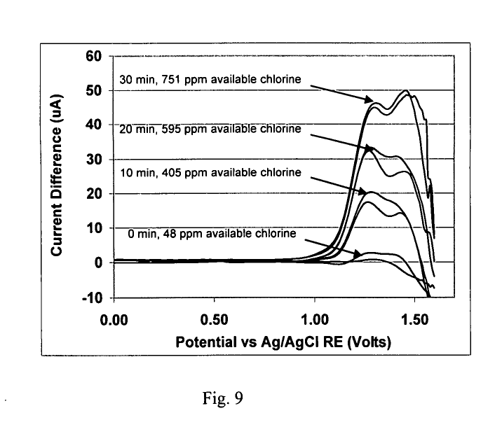

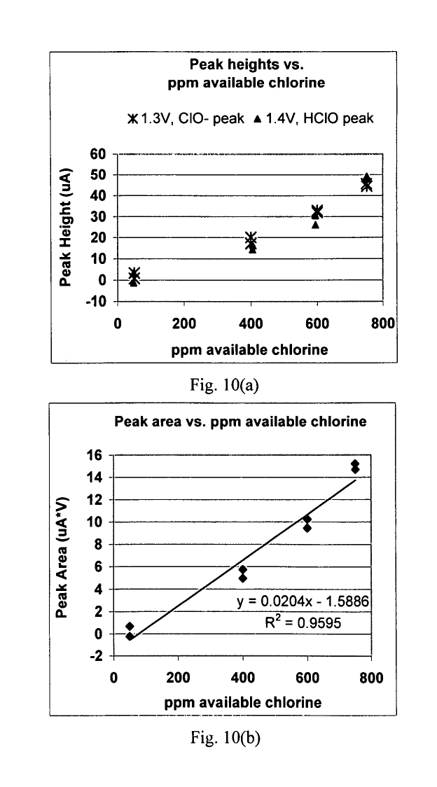

The capability of sensor 11 (with a 10 mm² BDD working electrode) to monitor oxidants in-situ as they are generated was tested by performing a differential pulse non-stripping voltammetry scan every 10 minutes as an electrochlorinator was run using seawater as the chloride source to generate oxidants. As shown in FIG. 9, the resulting response peaks were compared to concentration indicated by iodometric titrations that were performed simultaneously during the scans. The scans produced double peaks, reflecting the presence of both HClO and ClO⁻ due to pH ranging from 7-8. Iodometric titration cannot distinguish these 2 species, but, as seen in FIG. 10(a), plots of peak heights for both HClO and ClO⁻ showed good correlation with the iodometric titrations because pH was fairly stable and, therefore, proportions of the total available chlorine present as HClO and ClO⁻ did not vary significantly. FIG. 10(b) shows a linear correlation of total response area (hypochlorite and hypochlorous acid responses) to total available chlorine concentration.

The embodiments of the present invention described above are intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A method for detecting at least one oxidant species in a sample, the method comprising the steps of:
(a) providing a sensor, the sensor comprising
(i) a working electrode, the working electrode comprising a boron-doped diamond electrode,
(ii) a counter electrode,
(iii) a reference electrode,
(iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and
(v) a computer, the computer being electrically coupled to the potentiostat to control the voltage applied by the potentiostat and to record the resulting current detected by the potentiostat;
(b) exposing the working electrode, the counter electrode, and the reference electrode of the sensor to the sample;
(c) operating the potentiostat, using differential pulse non-stripping voltammetry, to apply a voltage between the working electrode and the reference electrode in such a manner as to cause the generation of a current between the working electrode and the counter electrode that is indicative of the at least one oxidant species to be detected, whereby said current is measured by the potentiostat; and
(d) comparing the measured current to an appropriate standard for the at least one oxidant species.

2. The method as claimed in claim 1 wherein said comparing step comprises comparing the measured current to an appropriate standard for determining the concentration of the at least one oxidant species.

3. The method as claimed in claim 1 wherein said boron-doped diamond electrode comprises a boron-doped diamond microarray.

4. The method as claimed in claim 1 wherein said boron-doped diamond electrode comprises a high surface area boron-doped diamond electrode.

5. The method as claimed in claim 1 wherein said counter electrode comprises a platinum counter electrode.

6. The method as claimed in claim 1 wherein said reference electrode comprises a silver/silver chloride reference electrode.

7. The method as claimed in claim 1 wherein said differential pulse non-stripping voltammetry comprises scanning anodically.

8. The method as claimed in claim 1 wherein said differential pulse non-stripping voltammetry comprises scanning cathodically.

9. The method as claimed in claim 1 wherein said differential pulse non-stripping voltammetry comprises scanning in one of an anodic direction and a cathodic direction and then scanning in the other of the anodic direction and the cathodic direction.

10. The method as claimed in claim 1 wherein said at least one oxidant species is selected from the group consisting of hypochlorite, hypochlorous acid, chlorite, chloride anion, and bromide anion.

11. A method for detecting more than one oxidant or halide anion species in a sample, the method comprising the steps of:
(a) providing a sensor, the sensor comprising
(i) a working electrode, the working electrode comprising a boron-doped diamond electrode,
(ii) a counter electrode,
(iii) a reference electrode,
(iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and
(v) a computer, the computer being electrically coupled to the potentiostat to control the voltage applied by the potentiostat and to record the resulting current detected by the potentiostat;
(b) exposing the working electrode, the counter electrode, and the reference electrode of the sensor to the sample;
(c) operating the potentiostat, using differential pulse non-stripping voltammetry, to apply a voltage between the working electrode and the reference electrode in a scanning manner that distinguishes the different species to be detected by the generation of a current between the working electrode and the counter electrode at a characteristic potential, whereby said current is measured by the potentiostat; and
(d) comparing the measured current to appropriate standards to enable more than one oxidant or halide anion species to be detected and distinguished from one another.

12. The method as claimed in claim 11 wherein said comparing step comprises comparing the measured current to appropriate standards for determining the concentrations of each of the detected oxidant or halide anion species.

13. The method as claimed in claim 11 wherein said boron-doped diamond electrode comprises a boron-doped diamond microarray.

14. The method as claimed in claim 11 wherein said boron-doped diamond electrode comprises a high surface area boron-doped diamond electrode.

15. The method as claimed in claim 11 wherein said counter electrode comprises a platinum counter electrode.

16. The method as claimed in claim 11 wherein said reference electrode comprises a silver/silver chloride reference electrode.

17. The method as claimed in claim 11 wherein said differential pulse non-stripping voltammetry comprises scanning anodically.

18. The method as claimed in claim 11 wherein said differential pulse non-stripping voltammetry comprises scanning cathodically.

19. The method as claimed in claim 11 wherein said differential pulse non-stripping voltammetry comprises scanning in one of an anodic direction and a cathodic direction and then scanning in the other of the anodic direction and the cathodic direction.

20. The method as claimed in claim 11 wherein said more than one oxidant or halide anion species is selected from the group consisting of hypochlorite, hypochlorous acid, chlorite, chlorate, bromate, chloride anion, and bromide anion.

21. A method for detecting at least one halide anion species in a sample, the method comprising the steps of:
(a) providing a sensor, the sensor comprising
(i) a working electrode, the working electrode comprising a boron-doped diamond electrode,
(ii) a counter electrode,
(iii) a reference electrode,
(iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and
(v) a computer, the computer being electrically coupled to the potentiostat to control the voltage applied by the potentiostat and to record the resulting current detected by the potentiostat;
(b) exposing the working electrode, the counter electrode, and the reference electrode of the sensor to the sample;
(c) operating the potentiostat, using differential pulse non-stripping voltammetry, to apply a voltage between the working electrode and the reference electrode in such a manner as to cause the generation of a current between the working electrode and the counter electrode that is indicative of the at least one halide anion species to be detected, whereby said current is measured by the potentiostat; and
(d) comparing the measured current to an appropriate standard for the at least one halide anion species.

22. The method as claimed in claim 21 wherein said comparing step comprises comparing the measured current to an appropriate standard for determining the concentration of the at least one halide anion species.

23. The method as claimed in claim 21 wherein said boron-doped diamond electrode comprises a boron-doped diamond microarray.

24. The method as claimed in claim 21 wherein said boron-doped diamond electrode comprises a high surface area boron-doped diamond electrode.

25. The method as claimed in claim 21 wherein said counter electrode comprises a platinum counter electrode.

26. The method as claimed in claim 21 wherein said reference electrode comprises a silver/silver chloride reference electrode.

27. The method as claimed in claim 21 wherein said differential pulse non-stripping voltammetry comprises scanning anodically.

28. The method as claimed in claim 21 wherein said differential pulse non-stripping voltammetry comprises scanning cathodically.

29. The method as claimed in claim 21 wherein said differential pulse non-stripping voltammetry comprises scanning in one of an anodic direction and a cathodic direction and then scanning in the other of the anodic direction and the cathodic direction.

30. The method as claimed in claim 21 wherein said at least one halide anion species is a chloride anion.

31. The method as claimed in claim 21 wherein said at least one halide anion species is a bromide anion.

32. A method for producing a chlorine-oxidant containing solution, said method comprising the steps of:
(a) providing an electrochlorinator;
(b) producing a chlorine-oxidant containing solution with the electrochlorinator;
(c) detecting the level of at least one chlorine-containing oxidant in the chlorine-oxidant containing solution; and
(d) providing feedback control of the electrochlorinator based on the detected level of the at least one chlorine-containing oxidant.

33. The method as claimed in claim 32 wherein said detecting step is performed continuously.

34. The method as claimed in claim 32 wherein said detecting step is performed periodically.

35. An electrolytic chlorination system comprising:
(a) an electrochlorinator for producing a solution containing at least one chlorine-containing oxidant; and
(b) a sensor, the sensor being fluidly coupled to the electrochlorinator for analyzing the solution produced by the electrochlorinator and being electrically coupled to the electrochlorinator for providing feedback control of the electrochlorinator based on analysis of the solution produced by the electrochlorinator.

36. The electrolytic chlorination system as claimed in claim 35 further comprising a circulation loop, the circulation loop coupled to the electrochlorinator to circulate the solution produced by the electrochlorinator, the sensor being fluidly coupled to the circulation loop.

37. The electrolytic chlorination system as claimed in claim 35 further comprising a fluid storage vessel, the fluid storage vessel being fluidly coupled to the electrochlorinator to store a quantity of the solution produced by the electrochlorinator, the sensor being fluidly coupled to the storage vessel to analyze the solution in the fluid storage vessel.

38. The electrolytic chlorination system as claimed in claim 35 wherein said sensor comprises:
(i) a working electrode, the working electrode comprising a boron-doped diamond electrode,
(ii) a counter electrode,
(iii) a reference electrode,
(iv) a potentiostat, the potentiostat being electrically coupled to each of the working electrode, the counter electrode, and the reference electrode so as to apply a voltage between the working electrode and the reference electrode and so as to measure current between the working electrode and the counter electrode, and
(v) a computer, the computer being electrically coupled to the potentiostat to apply a voltage between the working electrode and the reference electrode using differential pulse non-stripping voltammetry so as to cause the generation of a current between the working electrode and the counter electrode that detects one or more oxidant species to be detected and to record the resulting current detected by the potentiostat.
